(19) United States
(12) Patent Application Publication
(10) Pub. No.: US 2010/0258573 A1
(43) Pub. Date: Oct. 14, 2010

(54) Pressurised Container

(76) Inventor: Norbert Weber, Sulzbach/Saar (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/085,896

(22) PCT Filed: Sep. 26, 2006
(86) PCT No.: PCT/EP2006/009331

§ 371 Date: Jun. 2, 2008

(30) Foreign Application Priority Data
Jan. 25, 2006 (DE) 10-2006-004-121.6

(51) Int. Cl. F17C 1/16

(52) U.S. Cl. 220/586

(57) ABSTRACT

The invention relates to a pressurised container comprising two plastic casings (12, 14). The aim of the invention is to produce a leakproof container or storage arrangement which is economical to produce. To achieve this, a gap opening (24) between the casings (12, 14) extends up to a point, at which the casings (12, 14) are positioned together in a coaxial manner and an external support ring (22) comprising a wedge-shaped tapering (28) extends to said point, said external support ring being embodied as an individual piece or comprising at least two metal, ring-shaped individual segments (28, 30).

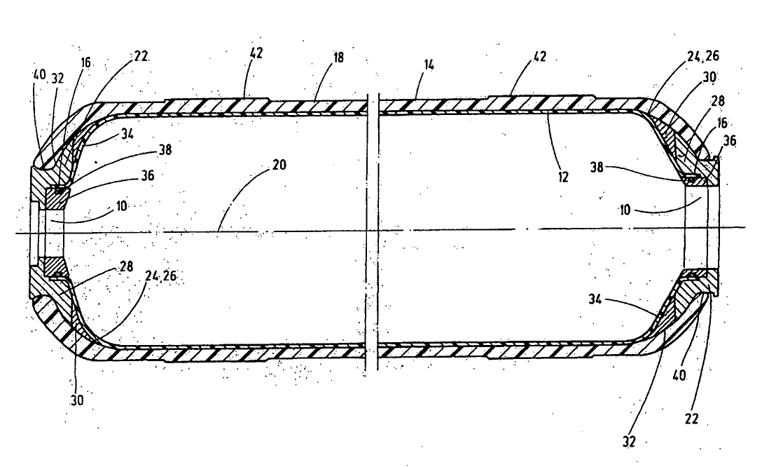

The invention relates to a pressurised container for holding at least one fluid medium, with a first plastic casing and a second plastic casing which at least partially encompasses the first plastic casing, the first plastic casing at least on its one end having a collar part which comprises an opening for the delivery and discharge of the medium, and the collar part and the plastic casing being supported on an interposed outside support ring which tapers in the manner of a wedge in the direction of the gap opening between the indicated casings.

EP 1 248 929 B1 discloses a plastic core container reinforced with a fiber plastic composite as the inner plastic casing for storing liquid and/or gaseous media under pressure, the core container having one of more fittings in the neck part and/or the bottom part and/or the cylindrical container part, of which at least one fitting is made to hold a screw-on pressure line feed which has a cylindrical or conical thread, such as, for example, a valve or a pipeline connection. In the connection shank of the plastic core container, a cylindrical insert with one collar end which runs peripherally or envelops on the end of the connecting shank is mounted as the collar part, at least two seals being arranged such that at least one seal is located between the insert and the inside surface of the plastic connection shank of the plastic core container and at least one other seal is located between the insert and pressure line supply. This is to ensure a high level of long-lasting tightness on the fitting even under extreme cyclic thermal and mechanical operating stresses. Due to the sharp deflection site of the first inner plastic casing in the direction of the collar part by approximately 90°, it cannot be precluded that as a result of the sharp deflection site harmful stress peaks will occur, and although the outside support ring between the outer and inner plastic casing within the gap opening formed thereby tapers conically or in the manner of a wedge to the outside, the resulting support takes place only within the essentially horizontally running contact region of the two indicated plastic casings, with the result that relative movements which can damage the plastic can occur between the casings in the indicated region during operation of the device.

DE 197 51 411 C1 discloses a generic composite pressurized container for storage of gaseous media under pressure with a plastic liner as the inner or first plastic casing, with two neck pieces located in the neck region and with a winding of a fiber composite material which reinforces the liner as the second plastic casing. In the neck piece which holds the gas check valve there is a clamp ring which can be screwed into this neck piece and which on the outer casing has a threaded section which is adjoined by an unthreaded, truncated cone-like section and the annular groove which is located between the internal threaded sections of the neck piece for holding a gasket extends radially into the neck piece and on the outside of the respective neck piece. In the region adjoining the collar, the arrangement is provided with at least one bead which extends radially to the outside over the entire periphery. Likewise, as in the above aforementioned solution, the wedge-like taper of the outside support ring extends only along the inner peripheral region on the neck piece along a horizontal plane which is formed by the liner and which in this respect, deflected in turn at a sharp right angle, ends in the collar part which encompasses the delivery and discharge of the medium. The solution which in turn seals very effectively for its implementation uses correspondingly great technical effort with several components.

On the basis of this prior art, the object of the invention is to further improve the known solutions such that a highly reliable pressurized container is formed in an economical manner at a reduced production cost. This object is achieved by a pressurized container with the features of claim 1 in its entirety.

In that, as specified in the characterizing part of claim 1, the gap opening between the casings is routed as far as the site at which the casings are in contact with one another in a coaxial arrangement, and in that the wedge-like taper of the outside support ring which is made in one piece or is composed of at least two annular individual metal segments leads as far as this site, a tight container or accumulator arrangement is formed which can be implemented with low production costs. The pressurized container according to the invention can be used for a plurality of applications and in that support takes place into the outer peripheral region of the two casings by way of an outside support ring which tapers in the manner of a wedge, relative movements which may occur between the plastic casings are accommodated by way of the outside support ring, and damaging delamination processes directly between the sensitive plastic materials are avoided in this way. The contour surfaces of the first and second plastic casing which face one another can be implemented based on the wedge-like routing of the outside support ring which leads into the outer peripheral region of the arrangement without sharp deflections and without sudden changes of direction; this enables especially careful delivery of force for the indicated plastic casings. The delivery of force is especially favorable when the outside support ring is made in one piece and then preferably consists of a plastically deformable plastic material, especially of a polymer material. Good results can, however, also be achieved when the outside support ring as a rigid support part body is composed of at least two individual segments, for example, in the manner of individual rings; this in turn simplifies production and therefore helps reduce production costs. If in this connection the outside support ring consists completely and therefore integrally of plastic material, it is moreover precluded that the plastic material of the casings can be damaged on the sharp-edged transition sites. For a metal individual ring-segment execution, conversely high stiffness for the container arrangement is achieved especially with respect to the collar part of the liner as the inner or first plastic material.

In one preferred embodiment of the pressurized container according to the invention, the outside contour of the outside support ring in the direction of the gap opening is moreover provided with a convex curvature and its opposite inside contour, proceeding from the gap opening, is allowed to run a straight slope which at the site of the entry of the collar part ends in a contact surface which is parallel to the longitudinal axis of the container. This configuration of the outside support ring with a convex curvature on the outside contour and plane-parallel configuration on the inside contour side leads to an especially favorable delivery of the force of the loads of the inside casing into the outside support ring which in this respect is further supported by the outer plastic casing by winding.

Other advantageous configurations of the pressurized container solution according to the invention are the subject matter of the other dependent claims.

The pressurized container according to the invention will be detailed below using one embodiment according to the invention. The sole FIGURE shows the important parts of the pressurized container in a longitudinal section, schematically and not to scale.

The pressurized container shown in the drawings is used to store liquid or gaseous fluid media which can be under a pressure of up to several thousand bar. It is provided on both ends with connection openings 10 for delivery and discharge of media, to which pressure lines and/or valves which are not shown can be connected and which, depending on the application, can be made and dimensioned differently for the pressurized container.

The pressurized container has a first plastic casing 12 and a second plastic casing 14 which at least partially surrounds the first plastic casing 12. This first plastic casing 12 is also referred to as a plastic core container or liner in the jargon of the trade. It preferably consists of polyamide and is obtained by means of a blow molding process or by rotary sintering. These production processes are conventional so that they will not be detailed here. The indicated liner 12 is reinforced on the outer peripheral side by a fiber winding which has been wound on from the outside as the second plastic casing 14. For example, the reinforcing winding consists of a fiber reinforcement such as carbon fibers, aramid fibers, gas fibers, boron fibers, Al₂O₃ fibers or of mixtures thereof, which are also called hybrid yarns which are embedded in a basic matrix of duromers, for example epoxy or phenolic resins or in thermoplastics, for example, in the form of PA12, PA6, PP, etc. The fiber composite material which forms the support jacket in this respect contains fiber strands which are embedded in the plastic resin, which cross one another, and which extend essentially in the longitudinal and peripheral direction. The fiber composite material which forms the support jacket can in addition or alternatively also comprise fiber strands which cross one another, which are tilted in the longitudinal and peripheral direction and in one advantageous development of the longitudinal axis of the plastic core container can be assigned to one another tilted in mirror image. The forces directed longitudinally and peripherally can be optimally accommodated by the pressurized container in this way. Moreover, the possibilities are improved for adjusting the ratio of the opening cross section of a face-side opening with reference to the inside diameter of the plastic core container to large values of at least 30%, preferably of at least 50%, without adversely affecting operation.

On its opposing ends the first plastic casing 12 ends in one cylindrical collar part 16, and for an embodiment which is not detailed it would also be conceivable to close one end of the first plastic casing 12 and to provide only one collar part 16. The pressurized container is made essentially rotationally symmetrical and extends along its center periphery 18 with a coaxial arrangement of its two casings 12, 14 along its longitudinal axis 20. Viewed in the direction of this longitudinal axis 20, the free end of the second plastic casing 14 ends above the collar part 16 of the first plastic casing 12; this has proven favorable for the forces to be delivered during operation of the container. The collar part 16 of the first plastic casing 12 and the second plastic casing 14 are otherwise supported on the outside support ring 22 which lies inside between them. The outside support ring 22 tapers in the direction of the gap opening 24 between the indicated casings 12, 14 in the manner of a wedge. Provision is made according to the invention so that the indicated gap opening 24 between the casings 12, 14 is routed as far as the location at which the casings 12, 14 in a coaxial arrangement to the longitudinal axis 20 of the accumulator are in contact with one another, the wedge-like taper 26 of the outside support ring 22 leading as far as this site. The outside support ring is either made in one piece, which is not shown, or, as shown in the FIGURE, is composed of at least two annular individual segments 28, 30 of metal.

As furthermore follows from the FIGURE, the outside contour 32 of the outside support ring 22 in the direction of the gap opening 24 is provided with a convex curvature and its opposite inside contour 34 runs, proceeding from the gap opening 24, in a straight slope which ends at the site of the entry of the collar part 16 in a contact surface which is parallel to the longitudinal axis 20 of the container. The curvature of the outside contour 32 increases in the direction of the free end of the second plastic casing 14. This inside and outside contour configuration for the outside support ring 22 ensures good delivery of force and moreover reliable coupling of the indicated plastic casings 12, 14 in the region of the outside support ring 22. If the outside support ring 22, as shown, consists of individual metallic segments, at least one of the two individual segments 28 or 30 in the edge-side region can have a projection which ends in the manner of an overlap in an edge-side radial depression of the other individual segment. In this way especially good adhesion of the two individual segments to one another is possible. Viewed in cross section as shown in the FIGURE, accordingly one individual segment 30 is made in the manner of a feed edge and the other individual segment 28 as far as the free end of the respective collar part 16 is made in the manner of a parallelogram.

The collar part 16 of the first casing 12 is supported on the inner peripheral side on another contact surface of the inside support ring 36 which is likewise made as a rigid metal ring. As the FIGURE shows, the inside support ring 36 need not be made identical for the two ends of the pressurized container; but it is characteristic that the respective inside support ring 36 along its outer peripheral surface has an annular groove for holding the O-ring 38 which is used to seal the respective delivery and discharge of the medium. Furthermore, it is characteristic that the inside support ring 36 is supported in the outside support ring 22 such that a common boundary wall for the delivery and discharge of the medium is formed. The illustrated inside support ring 36 in the direction of the interior of the pressurized container is provided with a contact bevel which has a tilt which is matched to the tilt of the bevel of the inside contour 34 of the outside support ring 22 and which corresponds especially to it. Furthermore, the outside contour 32 of the outside support ring 22 is provided with a ring-shaped recess 40 in which the assignable end of the second plastic casing 14 ends with contact.

On both sides of the center periphery 18 the second plastic casing 14 has a least one additional winding layer 42 which on the one hand helps to increase the bursting pressure and on the other ensures that in case of bursting any solid internal parts of the pressurized container or accumulator cannot be shot to the outside, but rather are retained by the additional winding 42. Depending on the overall length of the accumulator, this additional winding 42 may be present only once or repeatedly at discrete distances from one another. The indicated outside support ring 22 is able to uniformly distribute the stress peaks which occur in the manner of a pressure buffer and to deliver them into the two plastic casings 12, 14. In this way bulging of the pressurized container is effectively avoided. Since in the sense of sliding motion in the coaxial region extremely small delaminating relative movements can occur between the facing sides of the plastic casings 12, 14, it is sufficient in this respect to undertake support and separation of the layers or of the two casings 12, 14 from one another in the end-side enclosure region by the outside support ring 22. The illustrated cross sectional wedge shape of the outside support ring 22 is favorable to the extent it effectively counteracts the indicated relative displacements, for which the different configuration of the outside contour 21 to the inside contour 34 acts at the same time in a supportive manner. In spite of the circumstance that for the described pressurized container design only smooth surfaces are used, especially relative to the inside support ring 36 and the outside support ring 22, it is surprising that in this way a high-strength and stiff connecting part in the region of the collar part 16 is achieved in a structurally simple manner.

1. A pressurized container for holding at least one fluid medium, with a first plastic casing (12) and a second plastic casing (14) which at least partially encompasses the first plastic casing (12), the first plastic casing (12) at least on its one end having a collar part (16) which comprises an opening (10) for the delivery and discharge of the medium, and the collar part (16) and the second plastic casing (14) being supported on an interposed outside support ring (22) which tapers in the manner of a wedge in the direction of the gap opening (24) between the indicated casings (12, 14), characterized in that the gap opening (24) between the casings (12, 14) is routed as far as the site at which the casings (12, 14) are in contact with one another in a coaxial arrangement, and that the wedge-like taper (26) of the outside support ring (22) which is made in one piece or which is composed of at least two annular individual segments (28, 30) of metal is routed as far as this site.

2. The pressurized container according to claim 1, wherein the outside contour (32) of the outside support ring (22) in the direction of the gap opening (24) is provided with a convex curvature and its opposite inside contour (34), proceeding from the gap opening (24), runs in a straight slope which at the site of the entry of the collar part (16) ends in a contact surface which is parallel to the longitudinal axis (20) of the container.

3. The pressurized container according to claim 1, wherein the collar part (16) of the first casing (12) is supported on the inner peripheral side on another contact surface of the inside support ring (36) which is likewise made as a rigid metal ring.

4. The pressurized container as claimed claim 3, wherein the inside support ring (36) is supported in the outside support ring (22) such that a common boundary wall for the delivery and discharge of the medium is formed.

5. The pressurized container according to claim 3, wherein the inside support ring (36) in the direction of the interior of the pressurized container is provided with a contact bevel which has a tilt which corresponds to the tilt of the bevel of the inside contour (34) of the outside support ring (22).

6. The pressurized container according to claim 1, wherein the outside contour (32) of the outside support ring (22) is provided with a ring-shaped recess (46) in which the assignable end of the second plastic casing (14) ends with contact.

7. The pressurized container according to claim 1, wherein the first plastic casing (12) is a plastic liner which is produced by a blow molding or rotary or thermal process.

8. The pressurized container according to claim 1, wherein the second plastic casing (14) consists of a winding of at least one type of fibers which forms a fiber reinforcement for the first plastic casing (12) at the site of the respective enclosure.

9. The pressurized container according to claim 8, wherein the second plastic casing (14) along its outer periphery has an additional winding (42) at discrete distances from one another.
